(19) United States
(12) Patent Application Publication
(10) Pub. No.: US 2010/0256264 A1
(43) Pub. Date: Oct. 7, 2010

(54) USE OF A CITRATE/LIPID MIXTURE AS A PLASTICIZER FOR BIO-DEGRADABLE COMPOSITES

(75) Inventors: Jacques Barbier, Montamise (FR); Cedric Dever, Jaunay-Clan (FR); Stephane Soum, Migne-Auxances (FR)

Correspondence Address: YOUNG & THOMPSON, 209 Madison Street, Suite 500, Alexandria, VA, 22314, US

(73) Assignee: VALAGRO CARBONE RENOUVELABLE POITOU-CHARENTES, Poitiers (FR)

(21) Appl. No.: 12/742,143

(22) PCT Filed: Nov. 10, 2008
(86) PCT No.: PCT/FR2008/052024

§ 371 Date: May 10, 2010

(30) Foreign Application Priority Data
Nov. 8, 2007 (FR) 07 58878

(51) Int. Cl. C08L 3/00

(52) U.S. Cl. 524/47

(57) ABSTRACT

The use of at least one citrate/lipid mixture as a plasticizer for biodegradable polymer-based composites that are loaded with plant meal(s), and the biodegradable polymer-based composites loaded with plant meal(s) that comprise at least one citrate.

This invention relates to the use of a citrate/lipid mixture as a plasticizer of biodegradable polymer-based composites that are loaded with plant meal(s).

The invention also relates to biodegradable polymer-based composites that are loaded with plant meal(s) and that contain at least one citrate.

It is known that the controlled-biodegradability materials are increasingly sought after, in particular the materials that can break down in a natural environment without requiring that microorganisms, such as the materials that are based on mixtures of biodegradable polymer(s) and plant meal(s), be specifically supplied. These materials, based on biodegradable polymers or mixtures of biodegradable polymers and plant meals, are generally used by the implementation of techniques such as injection, blow molding, inflation molding, calendaring, etc., which require a significant fluidity in the molten state.

The biodegradable polymer mixtures that are loaded with plant meals have a low fluidity in the molten state, however.

One solution that is used to improve the fluidity of these materials is to add to them a plasticizer, for example a phthalate, a benzoate, an epoxide, etc., which makes it possible to generate a flexible product that is resistant and easier to manipulate. However, the plasticizers that are currently employed in the polymer industry are of a petrochemical, non-renewable origin, and are not biodegradable.

Ultimately, therefore, there are materials that are not ecological and that do not break down completely.

There is therefore a need for a product that can improve fluidity in the molten state of biodegradable polymers and biodegradable polymer-based formulations by preserving their mechanical properties and their degradable nature.

This is the purpose of this invention in proposing to use a citrate/lipid mixture as a biodegradable plasticizer of biodegradable polymer-based composites that are loaded with plant meal(s).

Preferably, the purpose of the invention is the use of a citrate/lipid mixture as a biodegradable plasticizer for improving the fluidity in the molten state of biodegradable polymer mixtures that are loaded with plant meals.

Citrate/lipid mixture means the combination between at least one citrate and at least one lipid.

The citrate or citrates of the mixture are added to the composites that are based on biodegradable polymer(s) and/or biodegradable polymer(s) loaded with plant meal(s).

The lipid or lipids of the mixture can be added to the composites that are based on biodegradable polymer(s) and/or biodegradable polymer(s) loaded with plant meal(s) or can be naturally present in the composites.

The invention also relates to the composites that are based on biodegradable polymer(s) and/or biodegradable polymer(s) loaded with plant meal(s), comprising at least one citrate.

Advantageously, this invention makes it possible to obtain formulations that are based on biodegradable polymers loaded with plant meal(s) that have a significant fluidity in the molten state while being degradable in a natural environment and therefore not being harmful to the environment.

These formulations also have significant thermal resistance.

Other characteristics and advantages will emerge from the following detailed description of the invention.

The purpose of this invention is therefore the use of at least one citrate/lipid mixture as a plasticizer of biodegradable polymer-based composites that are loaded with plant meal(s).

Preferably, the citrates are selected from among acetyl triethyl citrate, acetyl tributyl citrate, acetyl trihexyl citrate and acetyl trioctyl citrate.

The lipids can be selected from among saturated fatty acids (from C1to C32), mono-unsaturated fatty acids (palmitoleic acid, oleic acid, erucic acid, and nervonic acid) and poly-unsaturated fatty acids (linoleic acid, α-linolenic acid, γ-linolenic acid, di-homo-γ-linolenic acid, arachidonic acid, eicosapentaenoic acid, and docosahexanoic acid). The lipids can also be selected from among the glycerides, esters of fatty acids cited above, and glycerol.

The lipid or lipids of the mixture can be added to the composites that are based on biodegradable polymer(s) and/or biodegradable polymer(s) loaded with plant meal(s) or can be naturally present in the composites. It is therefore possible to have a citrate/lipid mixture without adding lipid to the biodegradable composites.

Preferably, the biodegradable composites comprise a citrate/lipid ratio of between 0.0001 and 10,000.

A citrate/lipid pair that is particularly suited to this invention can be, for example, acetyl triethyl citrate/stearin.

The composition that comprises at least one citrate and at least one lipid according to the invention is used as a plasticizer for composites that are based on at least one biodegradable polymer that is loaded with plant meal.

By way of example, the polymers can be selected from among:
Starch and starch mixtures,
Polypeptides,
Polyvinyl alcohol,
Polyhydroxyalkanoates, polyhydroxybutyrates, and polyhydroxyvalerates,
Polylactic acid and polylactates,
Cellulose, and
Polyesters.

The plant meals can be selected from among:
The amylased cereal meals, such as wheat, corn or rye meals,
The protein meals, such as horse bean, lupin, canola, sunflower, soybean, or casein meals, and
The lignocellulosic meals, such as fibers of wood, hemp or linen.

One example of a composite that is particularly suitable according to the invention is a composite that comprises at least one polylactic acid, at least one polyhydroxyalkanoate, meal of wheat, wood or plant fibers, and at least one citrate. In this case, the citrate is combined with lipids that are present in the plant meal to increase the plasticizing effect. It can optionally also contain additional lipids that are added to the composition of the composite.

According to a particular embodiment, the use according to the invention consists in extruding at least one mixture of biodegradable polymers, of plant meal, citrate, and optionally lipid, at temperatures of between 50 and 250° C., more particularly between 150 and 200° C.

Advantageously, the biodegradable polymer-based composites that are optionally loaded with plant meal and that are obtained according to the invention have good mechanical properties and fluidity in the molten state.

They have significant thermal resistance that can be more than 100° C.

The composites according to the invention can be used in various fields.

Advantageously, because of their particular properties, it is possible to use them in the field of transformation by calendaring, heat-forming, or injection.

These characteristics can be illustrated by the following example, implemented on polylactic acid (PLA)-based composites that are loaded with wheat meal. For this example:
The characteristics under tensile stress of the plastic materials have been determined according to the ISO/R 527 Standard,
The fluidity index in the molten state of plastic materials follows the ISO 1133 Standard, and
The resiliency of the materials has been determined according to the ISO 179 Standard from uncut samples.

The operating procedure is as follows.

Three mixtures, denoted as A, B and C, containing given proportions of PLA, wheat meal (Amo La Dorée, with a residual moisture level of 1%), and tri-n-butyl citrate have been extruded using a Clextral BC21 co-rotating extruder (L=600 mm, L/d=24) at 170° C. in the presence of 0 or 1 or 2% by mass of lipids (oleic acid or stearic acid).

The products that are obtained by granulation are injected in an Arburg 100T press so as to form samples that are necessary to their mechanical and rheological characterizations.

The results that are obtained are presented in the following table that indicates the mechanical and rheological characteristics of the products A, B and C that are compared to those of pure PLA:

| | | Sample | | | | | | | | |
|---|---|---|---|---|---|---|---|---|---|---|
| | | PLA | A | | | B | | | C | |
| Content by Mass of | | 0% | 8.7% | | | 8.7% | | | 10% | |
| Citrate in the | | | | | | | | | | |
| Mixture (%) | | | | | | | | | | |
| Content by Mass | | 0% | 0% | 2% | 2% | 0% | 1% | 2% | 0% | 2% |
| and Nature of Lipid | | | | Oleic | Stearin | | Oleic | Stearin | | Oleic |
| in the Mixture | | | | Acid | | | Acid | | | Acid |
| MFR (2.16 kg, | | 4.3 | / | 17.6 | 17.9 | / | 5.4 | 13.2 | / | 4.3 |
| 170° C.) g/10 min | | | | | | | | | | |
| Resiliency kJ/m² | | 15 | | | | | | | | |
| Flexion | Max. | 92 | 32 | / | / | 36 | 29 | 27 | 22 | 15 |
| | Constraint | 3,156 | 2,036 | / | / | 2,320 | 1,545 | 1,572 | 1,061 | 587 |
| | MPa | | | | | | | | | |
| | Flexion | | | | | | | | | |
| | Module | | | | | | | | | |
| | MPa | | | | | | | | | |
| Tensile | Maximum | 27 | 19 | 11 | 13 | 23 | 16 | 14 | 10 | 7 |
| Stress | Constraint | | | | | | | | | |
| | MPa | | | | | | | | | |
| | Extension | 3 | 2 | 2 | 2 | 2 | 4 | 4 | 75 | 85 |
| | to the | | | | | | | | | |
| | Rupture | | | | | | | | | |
| | Tensile | 1,564 | 1,550 | 1,008 | 1,437 | 1,775 | 890 | 1,044 | 907 | 377 |
| | Strength | | | | | | | | | |
| | Module | | | | | | | | | |
| | MPa | | | | | | | | | |

It is noted that the combination of citrate and lipid makes it possible to plasticize the composites A, B and C. Actually, relative to the PLA alone, the citrate/lipid mixture according to the invention makes it possible to improve the fluidity in the molten state of the composites A, B and C with a wheat-loaded PLA base, while making the material more flexible and therefore easier to work.

These results clearly show that the citrate/lipid mixture plays a plasticizer role while preserving the mechanical properties of the PLA as well as its degradable nature in a natural environment.

1-12. (canceled)

13. A biodegradable polymer-based formulation loaded with plant meal formulation comprising at least one citrate/lipid mixture as a plasticizer.

14. A method for improving fluidity of a biodegradable polymer-based formulation loaded with plant meal formulation in a molten state comprising adding at least one citrate/lipid mixture as a plasticizer to a biodegradable polymer-based formulation that loaded with plant meal.

15. The method according to claim 14, wherein the citrate/lipid ratio is between 0.0001 and 10,000.

16. The method according to claim 14, wherein the lipid is selected from the group consisting of saturated fatty acids, mono-unsaturated fatty acids, poly-unsaturated fatty acids and glycerides, esters of said fatty acids, glycerol and mixtures thereof.

17. The method according to claim 14, wherein the citrate is selected from the group consisting of acetyl triethyl citrate, acetyl tributyl citrate, acetyl trihexyl citrate, acetyl trioctyl citrate and mixtures thereof.

18. The method according to claim 14, wherein the citrate is acetyl triethyl citrate, and the lipid is stearin.

19. The method according to claim 14, wherein the addition comprises extruding at least one mixture of biodegradable polymers, plant meal and citrate at temperatures of between 50 and 250° C.

20. The method of according to claim 14, wherein the addition comprises extruding at least one mixture of biodegradable polymers, plant meal, and citrate at temperatures of between 150 and 200° C.

21. A biodegradable polymer-based composite loaded with plant meal comprising at least one citrate.

22. The composite according to claim 21, wherein,
the biodegradable polymer comprises at least one polylactic acid and at least one polyhydroxyalkanoate; and
the plant meal comprises meal of wheat, wood or plant fibers.

23. The composite according to claim 21, further comprising a lipid.

24. The composite according to claim 23, wherein, the at least one citrate is acetyl triethyl citrate, and the lipid is stearin.
